(19) United States
(12) Patent Application Publication
(10) Pub. No.: US 2012/0271745 A1
(43) Pub. Date: Oct. 25, 2012

(54) Indicators that Represent Quantity of Unmatched Bids or Offers

(75) Inventor: Brian J. Buck, Lisle, IL (US)

(73) Assignee: TRADING TECHNOLOGIES INTERNATIONAL, INC., Chicago, IL (US)

(21) Appl. No.: 13/090,909

(22) Filed: Apr. 20, 2011

(51) Int. Cl. G06Q 40/00

(52) U.S. Cl. 705/37

(57) ABSTRACT

Some embodiments relate to intelligently selecting one or more sets of indicators to optimally represent the overall quantity of bids or offers at a price level. The various sets of indicators may be selected based on the other sets of indicators that are displayed at that price level. By intelligently selecting the set of indicators, the trading device may reduce the time needed for a user to determine or estimate the exact quantity of bids or offers at that price level. For example, the trading device may select a set of indicators that has the least number of indicators in a set or may select a set of indicators that is most easily understood by the trader.

### BACKGROUND

The presently described technology relates to an electronic trading system.

An electronic trading system generally includes an electronic exchange that publishes a data feed to subscribing client devices. A data feed is a series of one or more messages that include data that is related to a market for a tradeable object. For example, a data feed may include, among other things, an inside market, market depth, last traded price, and a last traded quantity. The inside market is the lowest available ask price (best ask) and the highest available bid price (best bid) in the market for a particular tradable object at a particular point in time. Market depth refers to quantities available at the inside market and may also refer to quantities available at other prices away from the inside market. The last traded price (LTP) is a price at which the tradeable object was last traded. The last traded quantity (LTQ) is a quantity that last traded.

A client device, upon receiving the data feed, may display information included in the data feed, such that a market participant can use the information when trading (buying or selling) a tradeable object. For example, the information may be displayed as part of a trading ladder. A trading ladder may display the inside market and allow a market participant to submit one or more orders to buy or sell at a particular price.

### BRIEF DESCRIPTION OF THE DRAWINGS

The drawings illustrate example embodiments. As such, the various embodiments should not be limited to the arrangements and instrumentality shown in the drawings. The following provides a brief description of the drawings.

FIG. 1 illustrates an example electronic trading system that may be used during electronic trading;

FIG. 2 illustrates an example of a trading ladder with representations of the quantity of unmatched bids and asks at certain price levels;

FIG. 3 illustrates an example of a trading ladder with sets of indicators that represent quantity of unmatched bids and asks at certain price levels;

FIG. 4 illustrates another example of a trading ladder with sets of indicators that represent quantity of unmatched bids and asks at certain price levels;

FIG. 5 illustrates an example of a trading ladder with sets of indicators that represent the quantity of unmatched bids and asks at certain price levels;

FIG. 6 illustrates another example of a trading ladder with sets of indicators that represent the quantity of unmatched bids and asks at certain price levels;

FIG. 7 illustrates an example of a trading ladder with indicators that are not associated with other indicators;

FIG. 8 illustrates an example of a configuration screen;

FIG. 9 illustrates an example of a method for displaying an indicator representing quantity of unmatched bids or offers;

FIG. 10 illustrates an example of a trading ladder with sets of indicators rendered in three dimensions (3D) that represent the quantity of unmatched bids and asks at certain price levels;

FIG. 11 illustrates an example of a trading ladder with sets of indicators rendered in 3D that represent the quantity of unmatched bids and asks at certain price levels, in which a previous set of indicators are also shown; and

FIG. 12 illustrates an example of a trading ladder with sets of indicators that represent the quantity of unmatched bids and asks at certain price levels, in which a previous set of indicators are also shown.

### DETAILED DESCRIPTION

### I. Overview

Various embodiments disclosed herein relate to displaying one or more sets of non-textual indicators at a price level. Each of the indicators in a set has a shared characteristic with other indicators in that set and the shared characteristic represents a specific quantity of unmatched bids or offers.

In an embodiment, a price level has multiple sets of indicators that represent a quantity of unmatched bids or offers (i.e., asks) at that price level. Each of the indicators, within a set of indicators, share one or more characteristics with the other indicators in that set. The shared characteristic(s) is/are associated with a specific quantity of bids or ask. In some embodiments, the shared characteristic may be size, color, or shape. The shared characteristic(s) may be preconfigured, such that the actual quantity of bids or offers being represented by the shared characteristic(s) is known to the user during a trading session.

During operation, as the quantity of bids or offers at a price level changes, the trading device may dynamically change (e.g., add, remove, or substitute) the indicators displayed in the various sets of indicators, such that the sets of indicators accurately represent the quantity of bids or offers in real time or almost real time. Using sets of indicators with shared characteristics may allow a user to quickly determine or estimate with greater accuracy the exact quantity of bids or offers at that price level.

It should be understood that while the present disclosure describes representing unmatched bids or offers, one skilled in the art would understand that other information may also be represented using similar sets of indicators with shared characteristics. For example, overall traded volume at a price level, last traded price or quantity, other statistical values, other theoretical values, or other calculated values may be represented using sets of indicators with shared characteristics. Of course, other information can be represented using the embodiments described herein; however, for sake of clarity, the present embodiments will be described using unmatched bids or offers.

It is also worth noting that the various embodiments disclosed herein are not limited in their application to the details of design and arrangement of the components set forth in the previous and following description or as illustrated in the drawings. Instead, the previous description, following description, and the drawings focus on presenting concepts of various embodiments that may stand alone or be combined with each other.

### II. Example Electronic Trading System

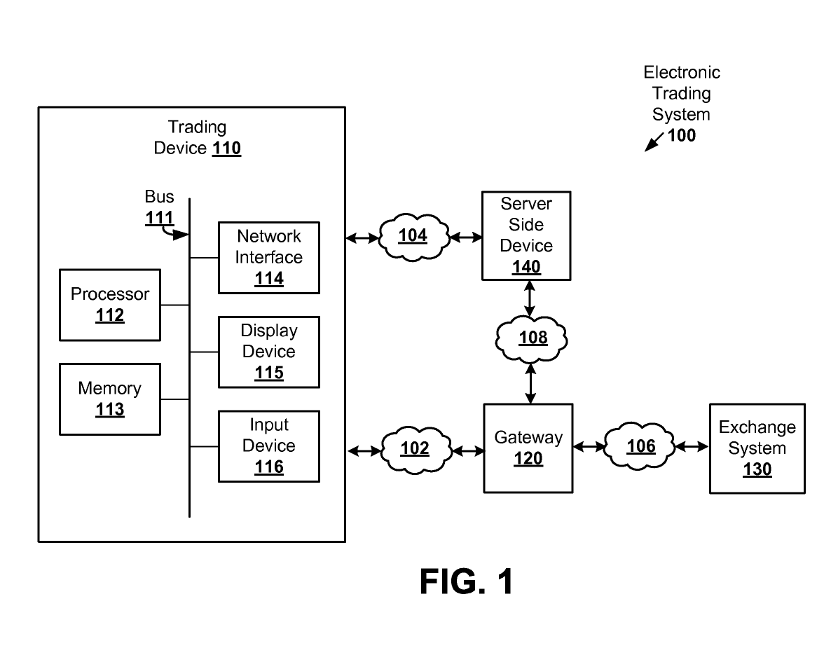

FIG. 1 is a block diagram illustrating an electronic trading system (“trading system”) 100. The trading system 100 includes a trading device 110, a gateway 120, and an electronic exchange system (“exchange system”) 130.

The trading system 100 may include additional, different, or fewer components. For example, as shown in FIG. 1 and discussed in more detail below, the trading system 100 may include a server side device 140 in communication with the trading device 110 and gateway 120. The server side device 140 may also directly communicate with the exchange system in some embodiment. In another example, depending on the trading environment, the trading system 100 may include multiple (for example, two or more) trading devices 110, multiple gateways 120, multiple exchange systems 130, multiple server side devices 140, or any combination thereof.

The trading device 110 is a client device, personal computer, a workstation, a desktop, a laptop, a mobile device, a handheld device, a network device, a server, a gateway, or other computing device or system. The trading device 110 is generally owned, operated, controlled, programmed by, configured by, or otherwise used by a user. As used herein, a “user” may include, but is not limited to, a human (e.g., a trader) or an electronic trading device (e.g., including a processor and memory or an algorithmic trading system). One or more users may be involved in the ownership, operation, control, programming, configuration or other use.

The trading device 110 includes a communication bus 111, a processor 112, memory 113, a network interface 114, a display device 115, and an input device 116. Of course, the trading device 110 may include additional, different, or fewer components. The components, either individually or in combination with each other, may be used for performing one, some, or all of the acts and functions described below or illustrated in the drawings.

During a trading session, for example, when a tradeable object is available to be bought and sold, the trading device 110 is used to electronically trade one or more tradeable objects that are listed at the exchange system 130. More specifically, when connected to the exchange system 130, the trading device 110 is used to submit a trade order for one or more tradeable objects. In some embodiments, the trade order is submitted via the gateway 120. However, in other embodiments, the server side device 140 is configured to receive information from the trading device 110 and submit a trade order to the exchange system 130 based on the information received from the trading device 110. Either way, upon receiving the trade order, the exchange system 130 enters the trade order into an exchange order book and attempts to match quantity of the trade order with quantity of one or more contra-side orders.

Unmatched quantity of the trade order is held in the exchange order book until quantity of the trade order is matched by the electronic exchange. Unmatched quantity of a trade order may also be removed from the exchange order book when the trade order is cancelled, for example, either by the trading device 110 or the exchange system 130. Upon matching quantity of the trade order, the exchange system 130 may send a confirmation to the trading device 110 that quantity of the trade order was matched.

In addition to receiving trade orders and matching them, the exchange system 130 may also transmit market data to the trading device 110 together in one feed or multiple data feeds. Market data may include data relating to, for example, price, quantity of bids at a price level, quantity of asks at a price level, the last traded quantity, a trade order, order fill data, and so on. For example, the exchange system 130 might send a price data feed to the client devices that provides a current inside market (e.g., a highest bid price and a lowest ask price). In another example, the exchange system 130 might send a market depth data feed to the client devices to provide the quantities available to be bought (bids) or sold (asks) at various price levels. Of course, the exchange system 130 might send combinations of data at the same or different times. For example, the current inside market and market depth data may be sent in the same or different data feeds.

### III. Displaying One or More Sets of Indicators

Upon receiving market data from the exchange system 130, for example, via the network interface 114, the trading device 110 may be configured to process the market data using the processor 112. The processor 112 may display the market data, for example, on the display device 116 of FIG. 1. As mentioned above, market data may include data related to, among other things, an inside market, market depth, last traded price, and a last traded quantity. Market depth refers to quantities available at the inside market and may also refer to quantities available at other prices away from the inside market. The quantity available at a price level is usually provided by the exchange system in aggregated sums. In other words, an exchange system usually provides the total buy (e.g., bid) quantity and the total sell (e.g., ask) quantity available in the market at a particular price level in its data feed.

The trading device 110 may display the market data as part of a trading screen. A trading screen is an electronic trading interface that enables a user to view a trading tool and perform electronic trading acts, such as setting order entry parameters or sending the order entry parameters, using the trading tool. Exemplary trading tools include charts, trading ladders, order entry tools, automated trading tools, automated spreading tools, risk management tools, order parameter tools, order entry systems, market grids, fill windows, and market order windows, combinations thereof, other now known or later developed electronic tools used for trading, preparing to trade, or managing trades.

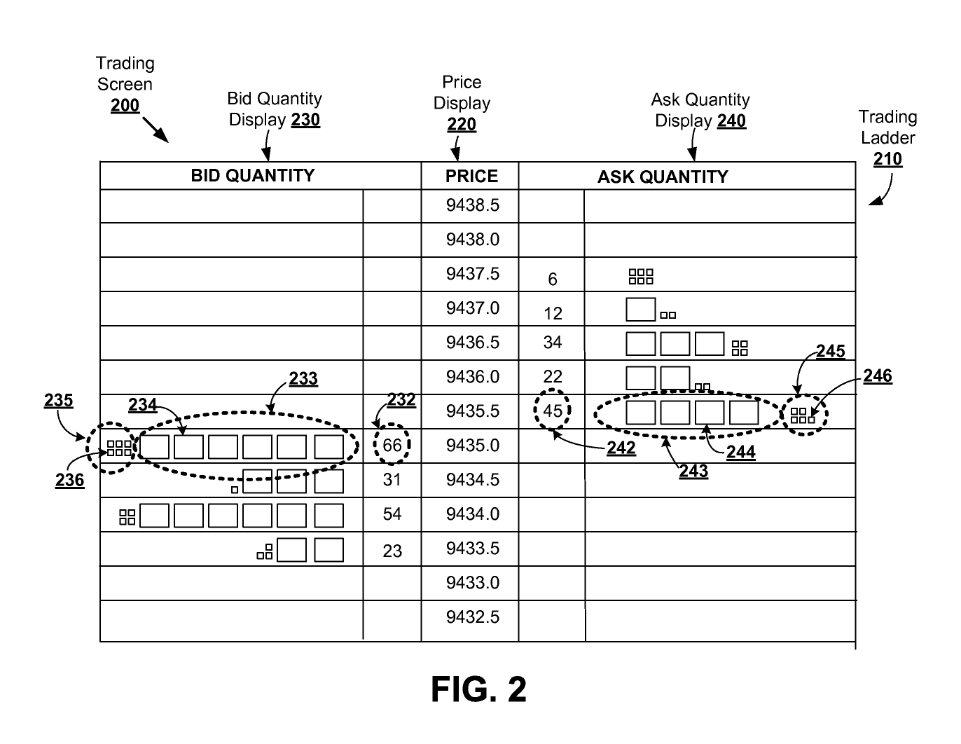

FIG. 2 shows an embodiment of a trading screen 200 with a trading ladder 210. The trading ladder 210 includes a price display 220, a bid quantity display 230, and an ask quantity display 240. The trading ladder 210 shown in FIG. 2 is simplified for sake of clarity. The trading ladder 210 may include additional, different, or fewer components or information. For example, in some embodiments, the trading ladder 210 may also display a last traded quantity, a volume traded at one or more price levels, and one or more working orders at various price levels. Furthermore, the trading ladder 210 may also include a trading tool for defining one or more parameters, such as a quantity or price. The parameters may be used as default parameters, for example. Additionally, as will be discussed in greater detail below, portions of the trading ladder may be removed and not displayed. For example, portions of the bid quantity display 230 and ask quantity display 240 may not be displayed on the trading ladder 210.

The price display 220 may represent various prices for a tradeable object. For example, as shown, the price display 220 may be a column of prices, where the prices increment in “ticks.” A tick is the minimum change in a price value that is set by the exchange for each tradeable object. The prices can be displayed as ticks, as multiples of ticks or in any other fashion. The price display 220 may list the whole prices or a portion of the whole prices (e.g., just the last two digits). Other price display conventions may alternatively be used, as long as the requisite price information is conveyed to the user. The prices in the price display 220 may be static (e.g., price levels do not normally change position unless a re-centering command is received) or dynamic (e.g., a display that always centers on last traded price).

Before explaining further, it should be noted that all or some of the information associated with each price value may be referred to as a price level. The information associated with a given price level may be located in the price display 220, bid quantity display 230, ask quantity display 240, other now known or later developed displays, or any combination thereof. In some embodiments, this may include only the price value. However, in other embodiments, the price level may include a representation of quantity of unmatched bids or offers at a given price value or other information.

The bid quantity display 230 may be used to represent the total quantity of unmatched bids at an electronic exchange or multiple, different electronic exchanges. The ask quantity display 240 may be used to represent quantity of unmatched asks at an electronic exchange or multiple, different electronic exchanges. The representations displayed in the bid quantity display 230 or ask quantity display 240 may be textual representations or non-textual representations.

It should be noted before explaining further that one or more cells in the trading ladder 210 may be used for one or more order entry actions. For example, one, some, or all of the cells in the bid quantity display 230 and ask quantity display 240 may be selected, for example, using a cursor or pointer controlled by an input device, such as a mouse. Selection of the cell may set, send, or set and send one or more parameters. By way of example, selecting the cell that is displaying “66” in the bid quantity display 230 may set a price parameter to “9435.0” and an order type parameter to “Bid.” In some embodiments, in addition to setting the price and order type parameters, selection of this cell may send a trade order, for example, with a default quantity parameter.

A. Overview Representation of Unmatched Bids or Offers

In some embodiments, the bid quantity display 230 and ask quantity display 240 may include an overview representation of the quantity of unmatched bids or offers at a price level. An overview representation represents the quantity of unmatched bids or offers with a single indicator. For example, as shown in FIG. 2, the bid quantity display 230 may include an overview representation 232 of the quantity of bids at a price level of “9435.0.” The overview representation 232 includes a numeric representation that indicates that there are “66” bids at this price level. Each price level has an overview representation of the quantity of bids available at that price level or quantity of bids available at that price level. In the event that there are zero bids at a price level, the order entry cell may display “0” or may be left blank. Similar to the bid quantity display 230, except that the quantity of asks are being represented, the ask quantity display 240 may include a column that has, for example, a textual representation of the quantity of asks at a certain price level.

Overview representations may dynamically change, for example, as an exchange receives additional trade orders, matches contra-side orders, trade orders are cancelled, or trade positions are changed. For example, the exchange may receive a trade order for “5” additional bids at the price level of “9435.0”. Accordingly, the numeric representation of bids at this price level may increase from “66” to “71.”

B. Sets of Indicators Representing Unmatched Bids or Offers

In some embodiments, the bid quantity display 230 and ask quantity display 240 may include sets of indicators that represent unmatched bids or offers at a price level. Each set may include a shared characteristic that is associated with all or a portion of the overall quantity of unmatched bids or offers at that price level.

i. Indicators

Indicators are squares, rectangles, circles, dots, stars, letters, numbers, cubes, or other now known or later developed shapes or designs. In an embodiment, an indicator may represent quantity of unmatched bids or offers without a textual or numeric value. For example, as shown in FIG. 2, indicators 234 and 236 are squares. One, some, or all of the indicators may be non-textual. An indicator may visually illustrate quantities of unmatched bids and asks at the various price levels without requiring a trader to read or comprehend a textual or numeric value. This visual illustration may be beneficial (e.g., require less time, involve less thinking, or be less complicated) for traders that comprehend and process non-textual representations faster than reading text.

However, in another embodiment, the indicators may be numbers or letters. For example, instead of the squares shown in FIG. 2, the indicators may be numbers, such as “5 5 5 5 5,” or letters, such as “a a a a a.”

ii. Sets of Indicators

A set of indicators may include one or more indicators. Each indicator in the set may be visually separated from the other indicators in the set, such that the user may be able to identify individual identifiers. That is, in the event that the set has a plurality of indicators, the individual indicators may have a visual spacing between each other. The actual spacing between identifiers may vary depending on, for example, user preference, characteristic(s) of the identifiers (e.g., larger identifiers may have a larger space), or other display factors. The spacing may be equal or non-equal spacing between all or some of the indicators. For example, in some embodiments, the space between a first pair of indicators may be the same size as the space between a second pair of indicators. However, in other embodiments, the space between the first pair of indicators may be a different size than the space between a second pair of indicators.

Each price level in a trading ladder is associated with zero, one, or more sets of indicators. For example, as shown in FIG. 2 and will be explained in more detail below, one or more sets of indicators may be displayed in the bid quantity display 230 or ask quantity display 240. However, in other embodiments, the sets of indicators may be displayed, for example, in a pop-up message when a cursor is moved over a price value. Of course, the sets of indicators may be displayed elsewhere on the trading screen, so long as a trader may determine that they are associated with a price value.

Depending on the number of unmatched bids or offers, each price level has zero, one or more sets of indicators. For example, in FIG. 2, the price level “9435.0” has a set 233 of six indicators 234 and another set 235 of six indicators 236 in the bid quantity display 230 because there are sixty-six unmatched bids. In another example, the price level “9438.0” has zero sets of indicators in either the bid quantity display 230 and ask quantity display 240 because there are zero unmatched bids or offers at this price level. In yet another example, the price level “9435.5” includes a set 243 of four indicators 244 and another set 245 of five indicators 246 in the ask quantity display 240 because there are forty-five unmatched asks.

In another example, which is not shown, the price level “9435.0” may have two sets of numbers as indicators. The first set may include “5 5 5 5 5” and the second set may include “1 1 1 1 1.” A space may be placed between each number to indicate that it is an individual number. Alternatively, or additionally, a dash may be provided between the numbers.

A set of indicators may represent quantity of unmatched bids or offers at a price level. The quantity represented by a set of indicators may be all or some of the total quantity of bids or offers at a given price level. For example, a set may represent only a portion of the total quantity of bids or offers at a price level. Accordingly, the combination of one or more sets may represent the aggregated sum of unmatched bids or offers for a given price level. At some price levels, as illustrated at the price level of “9435.0” in FIG. 2, individual sets of indicators (e.g., either set 233 or 235) may represent a portion of the aggregated sum. That is, the set 233 represents a portion of the aggregated sum of unmatched bids and asks and the other set 235 represents another portion of the aggregated sum. Accordingly, the total quantity of unmatched bids or offers at the price level of “9435.0” is represented by a plurality of sets. At other price levels, however, a single set of indicators represents the total quantity of bids or offers, for example, as illustrated at the price level of “9437.5.”

The combination of indicators in all of the sets at a particular price level, for example, as a whole or aggregated sum, may represent a single value, such as the total number of unmatched bids or offers. For example, as shown in FIG. 2, the indicators 234 in the set 233 and the indicators 236 in the set 235 may combine to represent the total bids at the price level of “9435.0.”

iii. Shared Characteristics

Each of the indicators within a set has one or more shared characteristics that are associated with a specific quantity of bids or offers. The term “associated with” may include mapped to, coupled with, representing, or otherwise paired with. The shared characteristics may include, for example, size, color, shading, numeric value, and shape. The characteristic(s) that is/are shared may differ for each set of indicators. For example, as shown in FIG. 2, the indicators 234 within the set 233 share a specific size. Whereas, the indicators 236 within the set 235 share a specific size that is different than the size of the indicators 234 in the set 233. More specifically, the indicators 236 are smaller than the indicators 234.

One or more shared characteristics are associated with a specific quantity of bids or offers. For example, the shared size of the indicators 234 may represent a quantity of “10” bids for each indicator 234 and the shared size of the indicators 236 may represent a quantity of “1” bid for each indicator 236. Accordingly, since there are six indicators 234 and six indicators 236, the overall quantity represented by these two sets 233, 235 of indicators is “66.” Namely, the set 233 represents sixty bids because the set 233 has six indicators, with each indicator representing “10” bids, and the set 235 represents six bids because the set 235 has six indicators, which each indicator representing “1” bid. Accordingly, the combination of set 233 and set 235 represent the overall quantity of bids at this price level. These sets are displayed in the bid quantity display 230.

Similarly, the ask quantity display 240 may include a set 243 of indicators 244 and a set 245 of indicators 246 for the price level of “9435.5.” The indicators 244, in set 243, share the same size as each other and indicators 246, in set 245, share the same size as each other. The shared size of indicators 244 is larger than the shared size of indicators 246. Based on the shared size, each indicator 244 may represent a quantity of “10” asks and each indicator 246 may represent a quantity of “1” ask. Accordingly, since there are four indicators 244, in set 243, and five indicators 246, in set 245, the overall quantity represented by these two sets 243, 245 of indicators is “45.” That is, the combination of set 233 and set 235 represent the overall quantity of bids at this price level and may be displayed in the bid quantity display 230.

Although FIG. 2 illustrates at most two sets per price level, the number of sets associated with a price level may exceed two. For example, a price level may have sets of indicators with small, medium, large, and extra-large indicators.

As discussed above, quantity of bids and asks may be associated with a relative size. For example, each size, such as small, medium, large, and extra-large, may be associated with a specific quantity of bids or offers. However, in some embodiments, a specific size, such as 1 cm×1 cm or 1 mm×1 mm, may be associated with a specific quantity of bids or offers. For example, 1 cm×1 cm may be associated with a quantity of “10.”

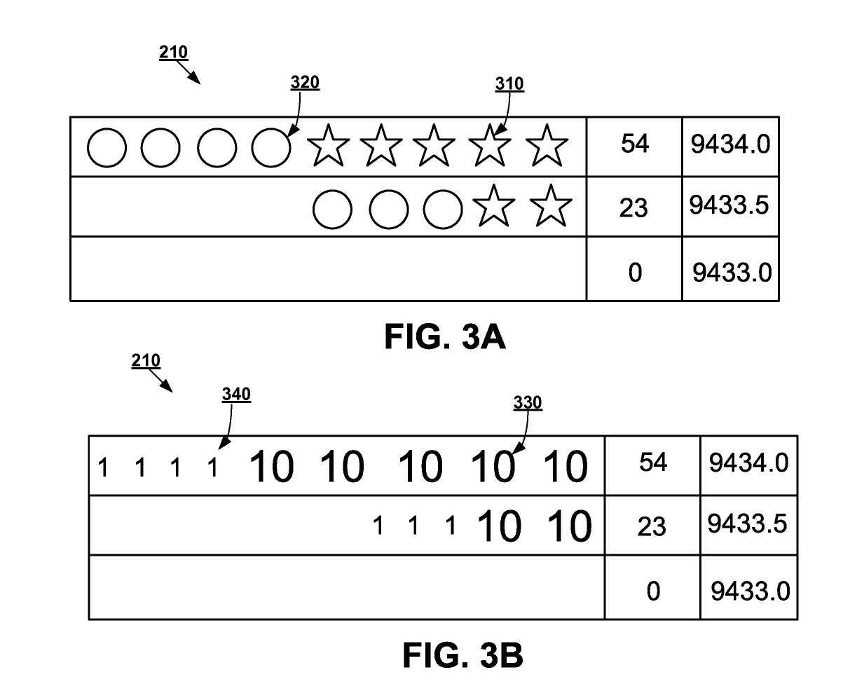

In some embodiments, other characteristics can be shared and associated with or mapped to specific quantities of bids or offers. For example, as will be explained below and shown in FIG. 3A, a shared shape may be associated with a specific quantity of bids or offers. In another example, as shown in FIG. 3B, the size of a number may be associated with a specific quantity of bids or offers.

FIG. 3A illustrates a portion of the trading ladder 210 of FIG. 2. In some embodiments, as shown in FIG. 3A, the shape or inner symbol of the indicators may be associated with a specific quantity of bids or offers. For example, a star shape 310 may represent a quantity of “10” and a circle shape 320 may represent a value of “1.” Other shapes may be used, such as character symbols (e.g., “!,” “@,” “#,” or “%”), textual value, numeric values, and other values may be represented by the shapes and symbols. The quantity of bids at the price level of 9434.0 is represented by five different star shapes 310 and four different circle shapes 320 because the quantity of bids at this price level is “54.” Likewise, the price level of 9433.5 is represented by two different star shapes and three different circle shapes. Since there are zero unmatched bids at the price level 9433.0, the quantity of bids may be represented by not displaying any shapes.

FIG. 3B illustrates a portion of the trading ladder 210 of FIG. 2. In some embodiments, as shown in FIG. 3B, the size of a number may be associated with a specific quantity of bids or offers. For example, as shown in FIG. 3B, 30 point font 330 may be associated with a quantity of 10 and 20 point font 340 may be associated with a quantity of 1.

In some embodiments, the color of the indicators represents the value. For example, “red” may represent a value of “100,” “green” may represent a value of “50,” and “blue” may represent a value of “10.” Other colors may be used to represent these or difference values. Furthermore, other values may be represented by colors. In yet another embodiment, sizes, shapes, colors, any combination thereof, or other indicators may be combined to represent values.

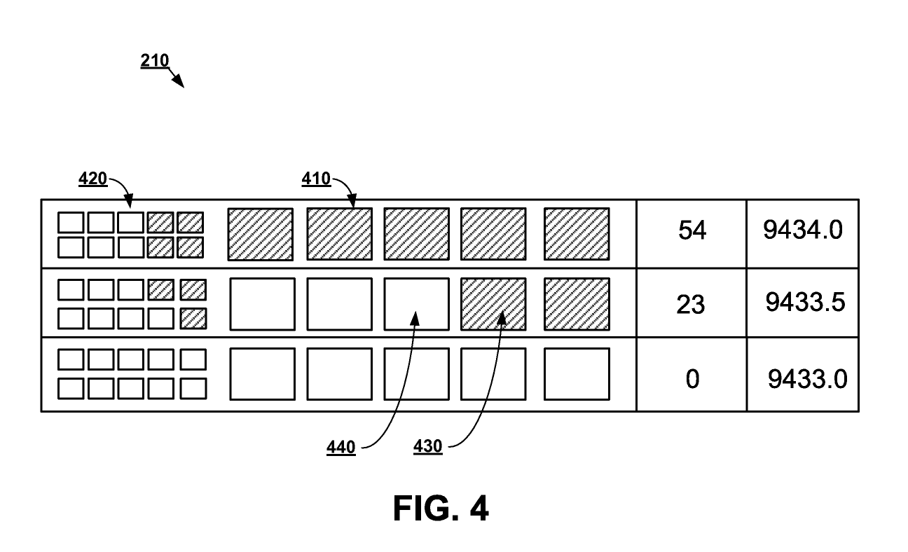

In some embodiments, as shown in FIG. 4, a combination (e.g., two or more) of shared characteristics may be used to represent quantity of bids or offers. As shown in FIG. 4, each price level has five large indicators 410 and ten small indicators 420. Depending on the quantity of bids for each price level, different variations of the large and small indicators are shaded, tinted, colored, flashing, or otherwise being displayed such that the indicator is representing a value. Accordingly, the size and shading of the indicators indicates quantity of bids or offers being represented by an indicator. In FIG. 4, the shading, tinting, coloring, or flashing is shown by the slanted lines 430, which represents that the indicator is representing a quantity of bids or offers. Whereas, in the event that the indicator is not shaded, tinted, colored, flashing, or otherwise representing quantity, as illustrated in the indicator 440, the indicator is not representing quantity of bids or offers. Of course, the opposite may also be true in some embodiments. That is, a non-shaded indicator may represent quantity of bids or offers and a shaded indicator may indicate that quantity is not being represented.

In FIG. 4, at the price level of “9434.0,” five large indicators 410 and four small indicators 420 are shaded and represent a quantity of “54” bids at that price level. In this example, each large indicator 410 that is shaded represents a quantity of “10” and each small indicator 420 that is shaded represents a quantity of “1.” Similarly, for the price level of “9433.5,” two large indicators and three small indicators are shaded to represent a quantity of “23” unmatched bids at this price level.

In some embodiments, one or more sets of indicators may represent a rounded quantity of unmatched bids or offers. The quantity of unmatched bids or offers may be rounded, for example, to the nearest whole number, nearest ten numbers, nearest hundred numbers, or other number and the plurality of indicators may represent the rounded number. For example, a bid quantity of “66” may be rounded to “70” and one or more sets of indicators representing “70” may be displayed.

iv. Configured Characteristics

The shared characteristic(s) of each set of indicators may be configured by a user. Configuring a characteristic relates to defining a characteristic (e.g., a size) and associating that characteristic with a specific quantity of bids and asks. The defined characteristic and specific quantity may be defaults (e.g., selected without user interaction) until a user changes either the defined characteristic or the corresponding quantity. By way of example, the larger indicators 234, 244 in FIG. 2 may be associated with a quantity of “10”. However, the smaller indicators 236, 246 may be associated with a quantity of “1”.

The indicators may be configured prior to a trading session or during a trading session. A trader may use a configuration screen to define which characteristics are associated with which values. For instance, some traders may want a “star” to be associated with a quantity of “10.” However, other traders may want a “circle” to be associated with a quantity of “10.” Using the configuration screen, or other configuration tool, the traders may configure the various associations how they desire to have them displayed.

In some embodiments, once configured the association between the shared characteristic and the quantity of bids or offers being represented is fixed. Accordingly, the indicators within a set of indicators are fixed (e.g., do not change), such that the indicators that are displayed are easily recognized and associated (e.g., by a trader) with a specific quantity of bids or offers. The sets of indicators, or even individual indicators, may represent quantity from the same or different trade orders. For example, the quantity being represented by an indicator may be made up of quantity from different trade orders and not just a single trade order.

v. Possible Benefits of Sets of Indicators

One possible benefit of using sets of indicators with shared characteristics is that both relative and exact determinations may be made about the quantity of bids or offers at a price level. Relative determinations may be made by visually comparing the quantity of bids or offers relative to a different price level based on the overall size of the indicators. For example, in FIG. 2, a trader may quickly determine that there are more bids at the price level of “9435.0” than at the price level of “9434.5.” Exact determinations may also be made using the sets of indicators with shared characteristics. Since shared characteristics are associated with specific quantities of bids or offers, a trader may quickly determine the exact quantity of bids or offers at a price level. For example, by glancing at the price level of “9434.5,” a trader may determine that there is an overall quantity of “31” bids, for example, because there are three larger indicators and one smaller indicator.

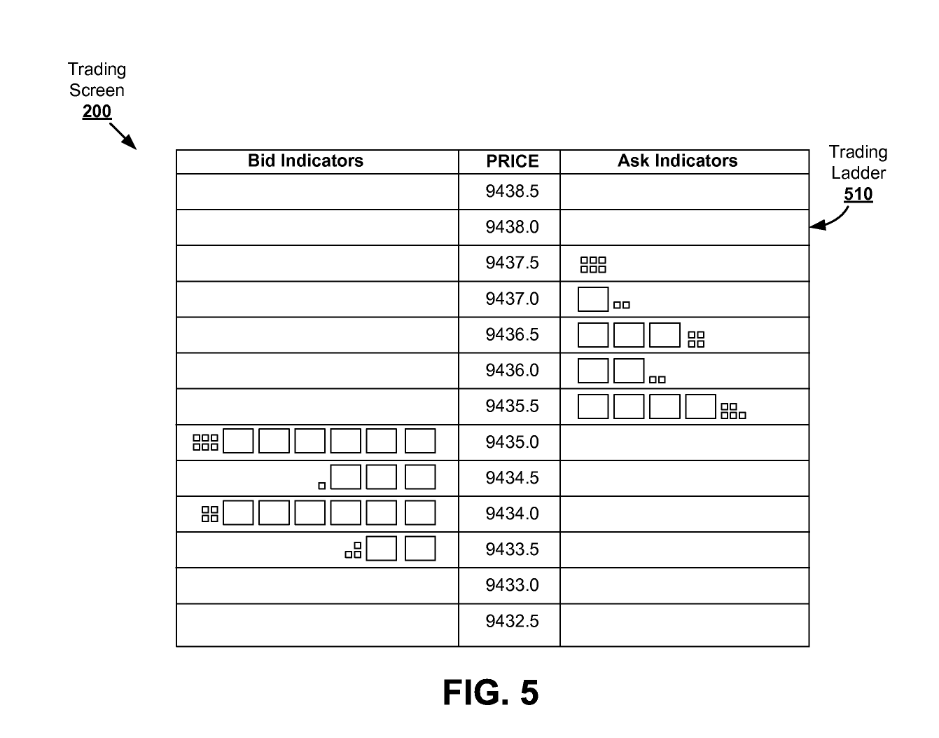

FIG. 5 shows yet another benefit of using sets of indicators. Using sets of indicators with shared characteristics may be beneficial because it may allow a trader to reduce the amount of information being displayed on a trading screen. For example, in an embodiment, as shown in FIG. 5, the textual representation of the quantity of bids and/or asks may be removed from the trading screen. The sets of indicators, because of the shared characteristics that are mapped to certain quantities, may replace the textual representation all together. The textual representation may not be included in the trading ladder.

vi. Combination of Textual and Non-Textual Representations

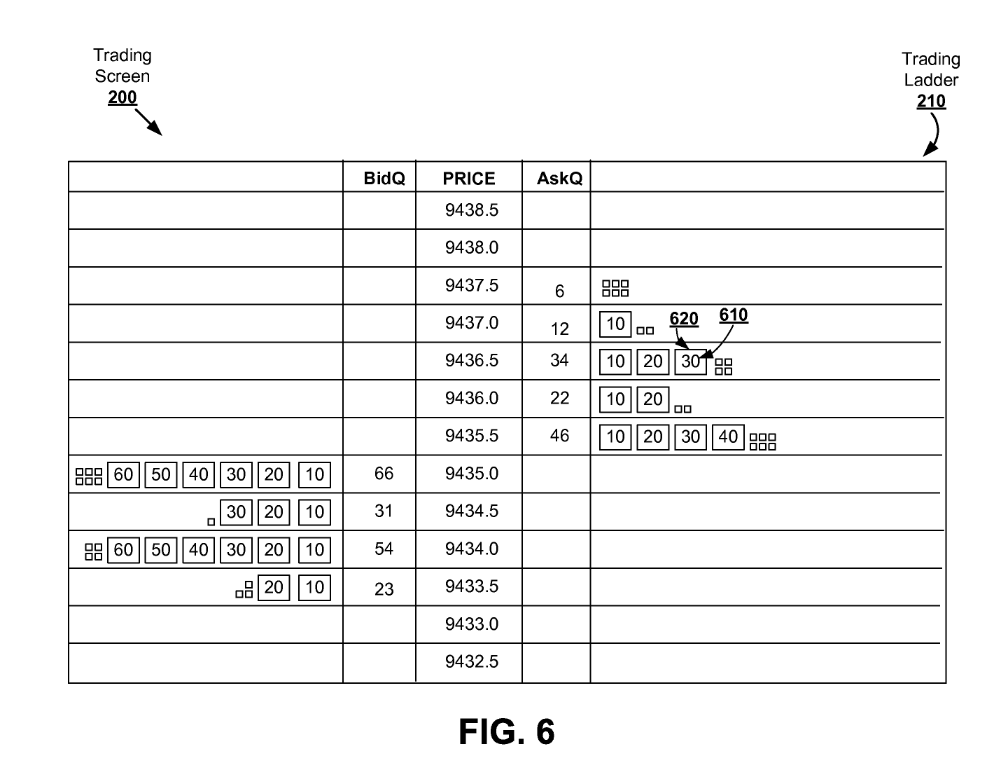

In some embodiments, as shown in FIG. 6, which shows the trading ladder 210 of FIG. 2, a textual indicator 610 may be used in combination with a non-textual indicator 620 to further represent the values or simplify the determination of the value. For example, the textual indicator 610 may be placed in, on, around the non-textual indicator 620. In another example, the textual indicator 610 may be associated with the non-textual indicator 620. An example of associating the textual indicator 610 with the non-textual indicator 620 may include displaying the textual indicator 610 when a cursor is moved over the non-textual indicator 652.

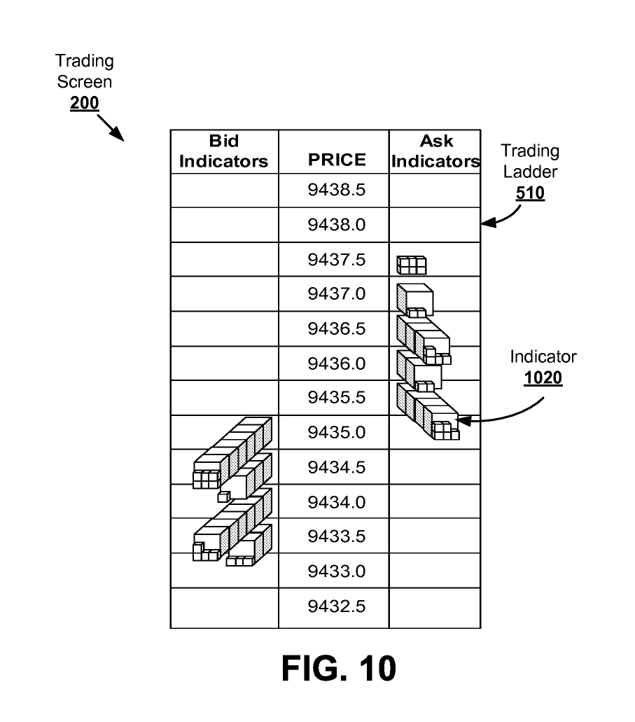

In an embodiment, the textual indicator 610 may represent the aggregate sum of the non-textual indicators 620. In FIG. 6, since each large indicator represents “10,” the textual indicator 610 may illustrate the sum of each large indicator. For example, as shown in FIG. 10, the first large indicator may include a textual representation of “10” and the next large indicator may include a “20” and the next large indicator may include a “30 and so on. However, in other embodiments, the quantity being represented by the textual indicator 610 (e.g., “10” for a large indicator) may be associated with each of the non-textual indicators 620. For example, each large indicator may have a “10” placed in, on, or around the non-textual indicator 620 or associated with the non-textual indicator 620.

As shown in FIG. 6, some sets may include textual representations associated with the non-textual indicators and other sets may not include textual representations. However, in other embodiments, all of the sets of indicators may include a supplementary textual representation.

### IV. Individual Indicators

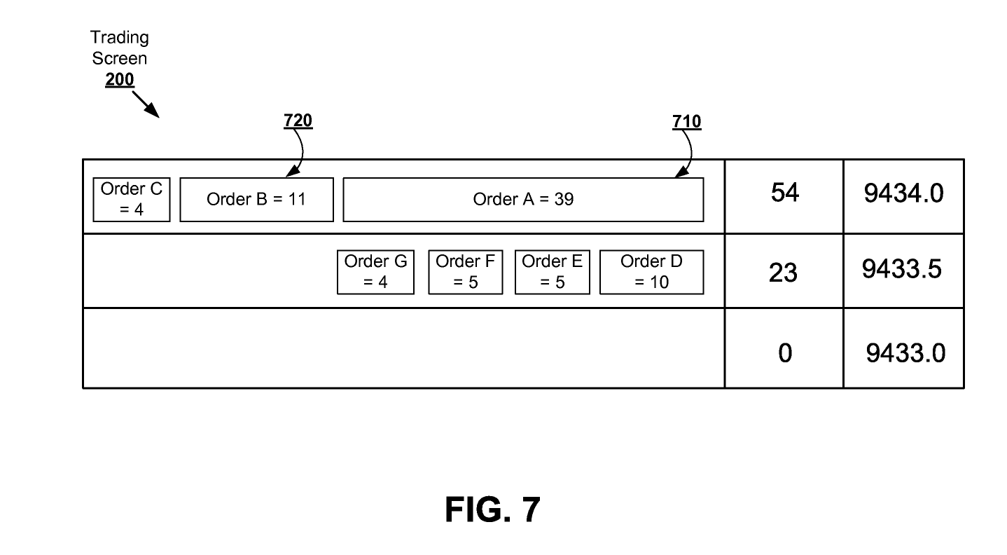

FIG. 7 illustrates an example embodiment where indicators do not share characteristics with other indicators in a set of indicators. In this example, each indicator represents in a trade order. More specifically, each indicator represents quantity of bids or offers defined in a trade order. Accordingly, each indicator is independent of the other indicators and does not rely or depend on the other indicators. In this example, sets of indicators are not displayed.

By way of example, in FIG. 7, an exchange system may receive a plurality of trade orders from one or more trading devices. For example, the exchange system may receive Order A (39 bids at a price of 9434.0), Order B (11 bids at a price of 9434.0), Order C (4 bids at a price of 9434.0), Order D (10 bids at a price of 9433.5), Order E (5 bids at a price of 9433.5), Order F (5 bids at a price of 9433.5), and Order G (4 bids at a price of 9433.5). The exchange system may send one or more data feeds including at least this information. The trading device may receive the information and displays an indicator for each of the trade orders received by at the exchange system. Each of the orders may be from the same or different trading device.

For example, the indicator 710 may be displayed to represent Order A. Indicator 710 has a size that corresponds to a quantity of “39.” The trading device may also display an indicator 720 representing Order B. The size of the indicator 710 and the size of indicator 720 are different. For example, the indicator representing “39” may be larger than the indicator representing “11.” Since these indicators are representing individual orders, they are not displayed in sets of indicators with shared characteristics. Instead, they are individually displayed.

In an embodiment, the sequence (e.g., order) of display of indicators for individual orders could correspond to the sequence in which the individual orders reside within the exchange's queue of orders at a particular price level. In an embodiment, the sequence of display of indicators for individual orders could be in descending order by size. In an embodiment, the order could be based on some other pre-configured ranking mechanism.

In an embodiment, the indicators such as 710 or 720 may have a visual attribute that indicates that a particular order is one of the trader's own orders. Such a visual attribute could include shading, border weight or line pattern, color, or other visual attributes. In an embodiment the indicators may additionally be visually coded (e.g., color coded) to identify which other orders are owned by the same trader. For example, if orders A and B represented by indicators 710 and 720, respectively, were orders owned by the same trader, then these two indicators could share a visual coded such as color or shading. The visual attribute may also indicate that that a particular order belongs to the trader or even someone in the trader's trading group.

In the preceding embodiments, there was a directed axis of layout for indicators that was orthogonal to the price axis and directed outward from the price axis, in the plane of the two-dimensional display. In an embodiment, the directed axis of layout could be orthogonal to the price axis but directed in a third spatial dimension from the plane of the two-dimensional display. For example, as shown in FIG. 10, an indicator 1020 is displayed so as to appear to be coming out of the screen towards the viewer. In this example, cubes of different sizes are used as the component indicators. The direction of the directed axis for layout for indicators could be in a direction toward or away from the viewer. The effect of three-dimensional (3D) display could be achieved by rendering onto a traditional two-dimensional display, or could take advantage of display techniques which are perceived by the viewer as monoscopic or stereoscopic images, such as 3D displays designed for viewing with active LCD shutter glasses, or 3D displays designed for viewing with passive polarized or anaglyph (colored) glasses, or 3D displays designed for viewing without special glasses.

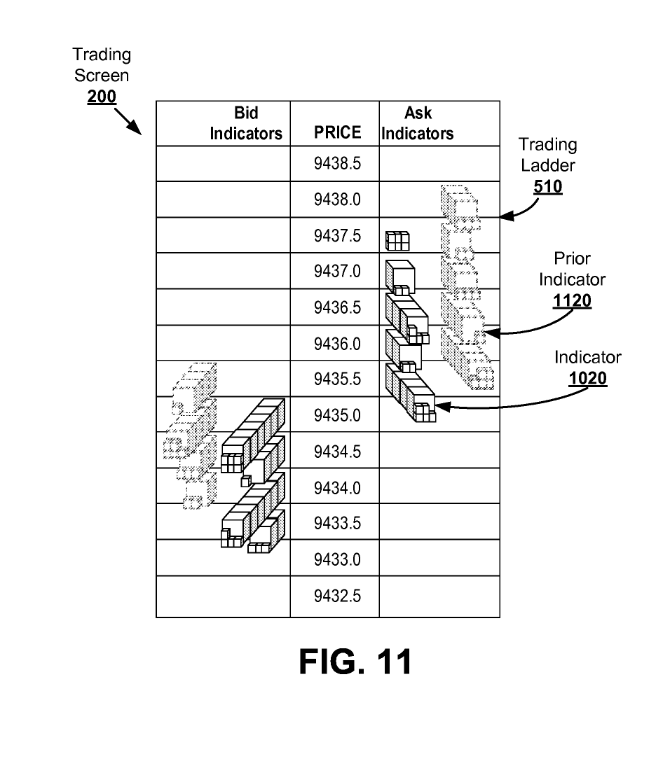

In the preceding embodiments sets of indicators are used to represent quantities of, for example, bids and offers, as they exist at a particular point in time. In an embodiment, there is also a plurality of additional indicators used to represent quantities at a different prior point in time. For example, FIG. 11, in contrast to FIG. 10, includes a display of indicators 1120 corresponding to a point in time prior to the primary indicator display. There is a benefit to the trader in being able to see not just the current state of the indicated quantities, but also the prior state of such quantities. There can be multiple such sets additional indicators each corresponding to a distinct prior time.

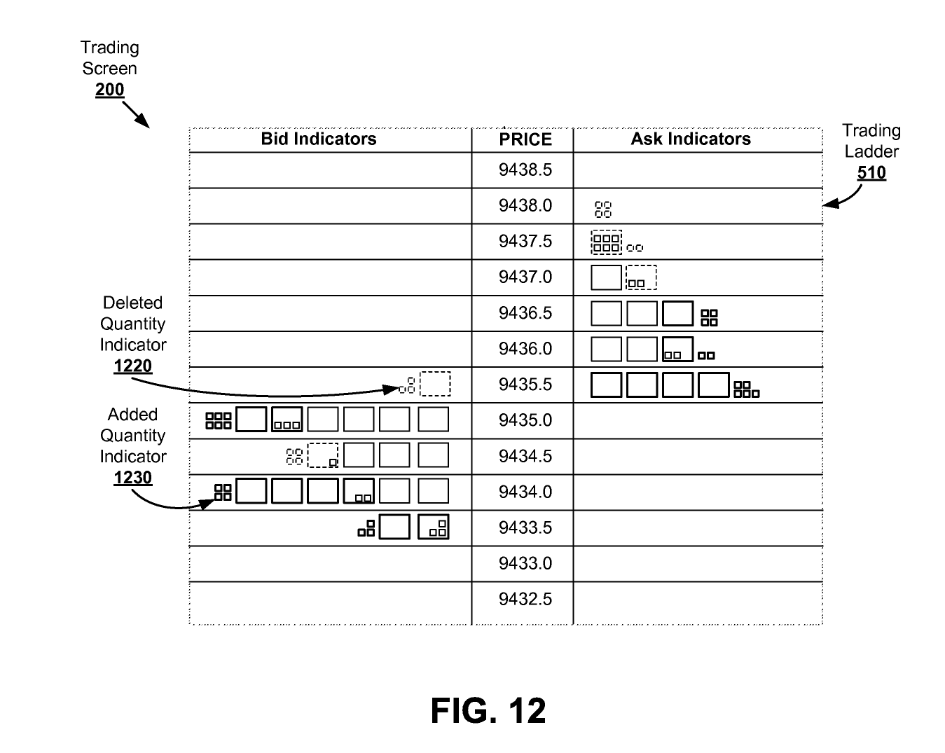

In an embodiment the change over time of the quantities represented by indicators can be display by using a visual emphasis, or different values for particular visual attributes, for newly added quantities (relative to a prior point in time) or newly deleted quantities (relative to a prior point in time). For example, FIG. 12 includes indicators 1220 that correspond to portions of a quantity that had been deleted relative to a quantity at a prior point in time. The deleted quantity indicator may be displayed with a different color/shade (gray vs. black) and/or a different border line type (dashed vs. solid) from the normal quantity indicators. The deleted quantity indicators 1220, in FIG. 12, are shown with dashed borders. FIG. 12 also includes indicators 1230 that represent portions of a quantity that have been newly added relative to a quantity at a prior point in time. The added quantity indicator is displayed in this example with a different border line weight (bold vs. normal) from the normal quantity indicators. In an embodiment the visual attributes that distinguish deleted and added quantity indicators can be animated over a short time period. For example, a deleted quantity indicator can be animated to gradually disappear. For example, an added quantity indicator can be animated to initially be displayed using its particular visual emphasis (e.g., bolded vs. normal) and to gradually change to the normal visual attributes.

### V. Configuration

As discussed above, a user may configure the association between the shared characteristics and the specific quantity of bids or offers being represented by the shared characteristic(s). This may include configuring the characteristic, configuring the quantity being represented, or configuring both characteristic and quantity being represented.

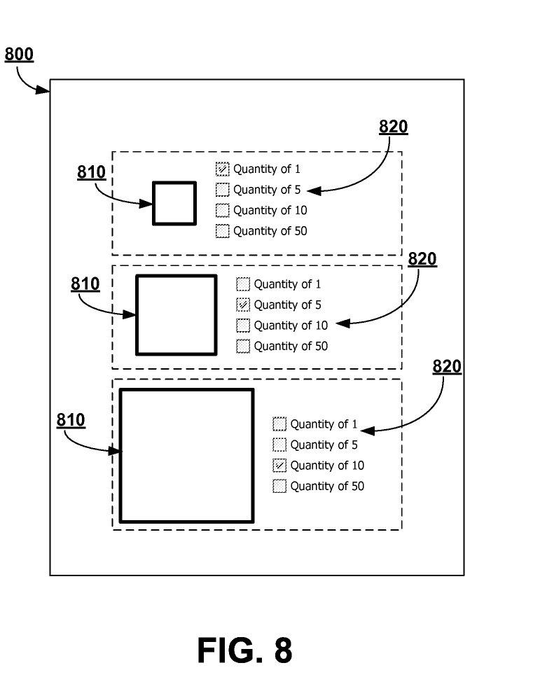

The user may configure the sets of indicators using a configuration screen or other configuration tool. For example, as shown in FIG. 8, a configuration screen 800 may be used to associate a specific quantity of unmatched bids or offers with one or more shared characteristics. In FIG. 8, a configuration screen 800 includes various quantities 810 that may be associated with one or more characteristics 820. The user may select the quantity that is to be associated with the one or more characteristics 820, for example, by defining the quantity to be associated. In this example, the user defines the quantity by selecting the quantity to be associated with the corresponding characteristic. However, in other embodiments, other tools may be used for associating specific quantities with one or more characteristics.

### VI. Selecting Optimal Sets of Indicators with Shared Characteristics

In an embodiment, a trading device may select the optimal sets of indicators to display. The optimal sets of indicators may be the combination of sets that is easiest for a trader to comprehend. This may include minimizing the number of sets, minimizing the total number of indicators in the various sets, minimizing the number of indicators representing small quantities, maximizing the number of indicators representing large quantities, or otherwise selecting sets of indicators that are quickly understood. The trading device may be configured to select the sets of indicators based on user preference. For example, a trader may prefer to minimize the number of total indicators being displayed on the trading ladder. Whereas, another trader may prefer to minimize the number of sets being displayed at the various price levels. The trading device may select the set of indicators based on this user preference.

In one example, the trading device may be configured to minimize the number of sets at the various price levels. Accordingly, the trading device may determine the total quantity of bids or offers at a price level, divide the total quantity of bids or offers by the largest quantity represented by an indicator (e.g., “10” in the example of FIG. 2) to maximize the number of indicators representing large quantities, and then divide the remaining quantity by the next largest quantity represented by indicators. This process may be repeated until the total quantity of bids or offers is represented by indicators. Each group of indicators may be displayed in a set of indicators.

### VII. Example Method for Displaying Indicators

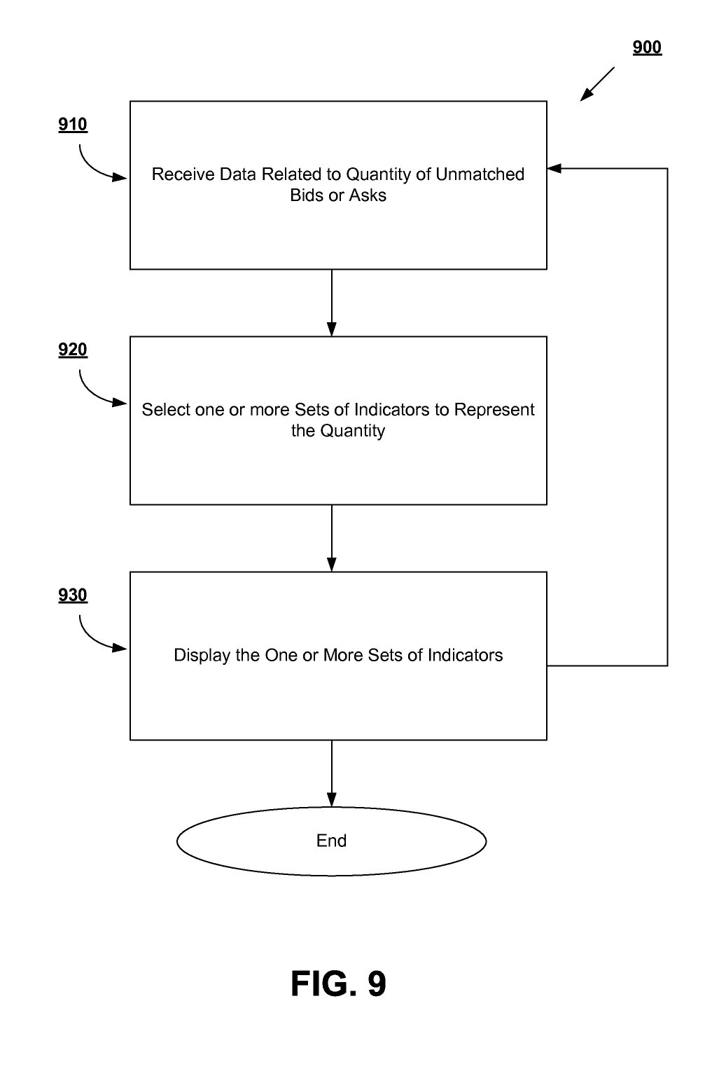

FIG. 9 illustrates an example of a method 900 for displaying an indicator representing quantity of unmatched bids or offers and a trading tool that assists with determining the quantity of unmatched bids or offers that are being represented. The method 900 includes receiving data related to quantity of bids or offers at one or more price levels 910, selecting one or more sets to represent the quantity of bids or offers 920, and displaying the sets of indicators in association with the corresponding price levels 930. The method 900 is implemented using the system 100 of FIG. 1 or a different system. For example, the trading device 110 of FIG. 1 may perform one, some, or all of the acts.

Before explaining further, it is noted that the acts shown in FIG. 9 may be performed in the order shown or a different order. Furthermore, the method 900 may include additional, different, or fewer acts. For example, in some embodiments, the method 900 may include only acts 920 or only act 930. Various combinations of the acts shown in FIG. 9, or even individual acts, may be performed as independent embodiments of the method 900 or may be combined with other acts described herein.

In act 910, a trading device receives market data from an exchange system. Market data can be transmitted from the exchange system via a gateway, a server side device, both a gateway and a server side device, or other now known or later developed device(s) for facilitating communication between the trading device and the exchange system.

The market data may include date related to quantity of unmatched bids or offers at one or more price levels. For example, the quantity of unmatched bids or offers may be the overall quantity (e.g., from all of the trade orders), quantity defined in a single trade order, quantity during a particular portion of the day, or some other quantity.

In act 920, the trading device analyzes the quantity of unmatched bids and asks and selects one or more sets of indicators to represent the quantity of unmatched bids or offers at a given price level. For example, the trading device may select an optimal set of indicators. An optimal set of indicators may be the combination of sets that is easiest for a trader to comprehend. This may include minimizing the number of sets, minimizing the total number of indicators in the various sets, minimizing the number of indicators representing small quantities, maximizing the number of indicators representing large quantities, or otherwise selecting sets of indicators that are quickly understood. The trading device may be configured to select the sets of indicators based on user preference. For example, a trader may prefer to minimize the number of total indicators being displayed on the trading ladder. Whereas, another trader may prefer to minimize the number of sets being displayed at the various price levels. The trading device may select the set of indicators based on this user preference.

In one example, the trading device may be configured to minimize the number of sets at the various price levels. Accordingly, the trading device may determine the total quantity of bids or offers at a price level, divide the total quantity of bids or offers by the largest quantity represented by an indicator to maximize the number of indicators representing large quantities, and then divide the remaining quantity by the next largest quantity represented by indicators. This process may be repeated until the total quantity of bids or offers is represented by indicators. Each group of indicators may be displayed in a set of indicators.

In act 930, the trading device displays the one or more sets of indicators at each price level. Displaying the one or more sets of indicators may include displaying on a display device, for example, continuously or periodically. For example, in some embodiments, the one or more sets of indicators may be displayed continuously at a given price level. However, in other embodiments, the one or more sets of indicators may be displayed in response to user input. For example, the one or more sets of indicators may be displayed when a user moves a cursor over a price level, clicks on a price level, or otherwise requests display of the one or more sets of indicators.

### VIII. Detailed Description of an Example Trading System

Referring back to FIG. 1, the trading device 110 is in communication with the gateway 120 via communication network 102. The trading device 110 is in communication with the server side device 140 via communication network 104. The gateway 120 is in communication with the exchange system 130 via communication network 106 and the server side device 140 via communication network 108. Communication between the various components of the trading system 100 may include direct communication and indirect communication through one or more intermediary components.

A communication network, such as communication network 102, 104, 106, or 108, can include hardware (for example, servers, routers, gateways, and switches), software (for example, a trading application or a communication application), transmission channels (e.g., T1 lines, T3 lines, Integrated Services Digital Network (ISDN) lines), telecommunication networks (e.g., data network, computer network, the Internet network, wide area network, local area network), or any combination thereof. Furthermore, a communication network may include wired, wireless, or both wired and wireless networks. The same or different communication networks may be used throughout the trading system 100. For example, communication network 102 may be the same as communication network 104.

The trading device 110 is a client device, personal computer, a workstation, a desktop, a laptop, a mobile device, a handheld device, a network device, a server, a gateway, or other computing device or system. For example, the trading device 110 may be a personal computer running a copy of X_TRADER®, which is an electronic trading platform provided by Trading Technologies International, Inc. of Chicago, Ill. As another example, the trading device 110 is a server running an automated trading tool, such as Autotrader™ or Autospreader®, which are also provided by Trading Technologies International, Inc. In yet another example, the trading device 110 is a collection of devices, such as a personal computer and a server, working in combination with each other.

The trading device 110 is generally owned, operated, controlled, programmed by, configured by, or otherwise used by a user. As used herein, the phrase “user” may include, but is not limited to, a human (e.g., a trader) or an electronic trading device (e.g., including a processor and memory or an algorithmic trading system). One or more users may be involved in the ownership, operation, control, programming, configuration or other use.

The trading device 110 may be used to electronically trade one or more tradeable objects. A tradeable object is an item that may be traded. Stocks, options, bonds, futures, currency, warrants, derivatives, traded events, goods, securities, and commodities are a few examples of tradeable objects. Tradeable objects may be “real” or “synthetic.” Real tradeable objects are products that are listed by an exchange. Synthetic tradeable objects are products that are defined by a user and are not listed by an exchange. For example, a synthetic tradeable object may include a combination of real (or other synthetic) products such as a synthetic spread created by a user utilizing the trading device 110.

In some embodiments, the trading device 110 prepares a trade order and sends the trade order to the exchange system 130 via the gateway 120, for example. However, in some embodiments, the trading device 110 may send one or more order entry parameters, such as a price parameter, quantity parameter, order type parameter, or other parameter to a management device, such as the server side device 140. The management device may prepare and send the trade order to the exchange system 130.

For instance, the trading device 110 may send order entry parameters, which are related to each other, at the same or different times to the server side device 140. Furthermore, order entry parameters may be sent in the same message or different messages. By way of example, a tradeable object parameter may be sent ahead of, or along with, a price parameter and quantity parameter that are sent to the trading strategy device or the server side device for the first time. The tradeable object parameter may be stored, for example, at the server side device. With the tradeable object parameter already at the server side device, subsequent incoming price and quantity parameters may be combined or used with the tradeable object parameter and sent collectively to the exchange system. If a change in the tradeable object parameter occurs, then an updated tradeable object parameter may be sent ahead of, or along with, price and quantity parameters following the change. In other embodiments, a price parameter, but not necessarily quantity parameter is sent to the gateway or server side device. For instance, a price parameter may be sent ahead of, along with, or after a quantity parameter.

A trade order, or even one or more order entry parameters, may be sent at the request from a user or automatically (e.g., without or with very little user interaction). For example, a trader may utilize the trading device 110 to place a trade order for a particular tradeable object. The trader may manually provide various parameters for the trade order such as an order price, quantity, or both price and quantity. As another example, a trading device 110 may automatically calculate one or more parameters for an order and automatically send the order. In some instances, a trading device 110 may prepare the order to be sent but not actually send it without confirmation from the trader.

As shown in FIG. 1, the trading device 110 includes a bus 111, a processor 112, a main memory 113, a data storage 114, a network interface 115, a display device 116, an input device 117, and an output device 118. The trading device 110 may include additional, different, or fewer components. For example, multiple buses, multiple processors, multiple main memory devices, multiple storages, multiple network interfaces, multiple display devices, multiple input devices, multiple output devices, or any combination thereof may be provided. In another example, the trading device 110 may not include an input device 117. Instead, for example, the trading device 110 may be controlled by an external or remote input device via the network interface 115.

The bus 111 is a communication bus, channel, network, circuit, or other mechanism for communicating data between components in the trading device 110. The bus 111 may be communicatively coupled with and transfer data between any of the components of the trading device 110. For example, during an installation process of a trading application, one or more computer-readable instructions that are to be executed by the processor 112 may be transferred from the data storage 114 or the network interface 115 to the main memory 113. When the trading device 110 is running or preparing to run the trading application stored in the main memory 113, the processor 112 may retrieve the instructions from the main memory 113 via the bus 111.

The processor 112 may be a general processor, digital signal processor, application specific integrated circuit, field programmable gate array, analog circuit, digital circuit, programmed processor, combinations thereof, or other now known or later developed processing device. The processor 112 may be a single device or a combination of devices, such as associated with a network or distributed processing. Any processing strategy may be used, such as multi-processing, multi-tasking, parallel processing, remote processing, or other processing strategy. Processing may be local or remote and may be moved from one processor to another processor.

The processor 112 may be operable to execute logic encoded in one or more tangible media, such as main memory 113 or data storage 114. As used herein, logic encoded in one or more tangible media includes instructions that are executable by the processor 112 or a different processor. The logic may be stored as part of software, hardware, integrated circuits, firmware, micro-code or other now known or later developed device for storing logic. The logic may be received from an external communication device via a communication network, for example, connected to the Internet. The processor 112 may execute the logic to perform the functions, acts or tasks illustrated in the figures or described herein.

The main memory 113 and data storage 114 may be tangible media, such as computer readable storage media. In an embodiment, computer readable storage media may be non-transitory. Computer readable storage media may include various types of volatile and non-volatile storage media, including but not limited to random access memory, read-only memory, programmable read-only memory, electrically programmable read-only memory, electrically erasable read-only memory, flash memory, magnetic tape or disk, optical media, any combination thereof, or any other now known or later developed tangible data storage device. The main memory 113 and data storage 114 may be a single device or, as shown in FIG. 1, different devices. The main memory 113 and data storage 114 may be adjacent to, part of, programmed with, networked with, or remote from processor 112, such that data stored in the main memory 113 and data storage 114 may be retrieved and processed by the processor 112, for example.

The main memory 113 and data storage 114 may be the same or different types of memory. For example, in one embodiment, the main memory 113 includes both random access memory (RAM) and read only memory (ROM). In this example, the RAM is a dynamic storage device that stores information and instructions to be executed by processor 112. The RAM also may be used for storing temporary variable or other intermediate information during execution of instructions to be executed by processor 112. The ROM is a static storage device for storing static information and instructions for processor 112. Furthermore, in this example, the data storage 114 may be a magnetic disk, optical disk, or flash memory for storing information to be processed by the processor 112 and instructions to be executed by the processor 112.

The main memory 113 and data storage 114 may store instructions that are executable by the processor 112. The instructions may be executed to perform one or more of the acts or functions described herein or shown in the figures. For example, the instructions are executed to perform one, some, or all of the acts shown in FIG. 2.

The network interface 115 may be a one-way or two-way communication coupling. Accordingly, the network interface 115 may communicatively connect one, two, or more communication networks or devices. For example, the bus 111 may be coupled with the communication network 102 and the communication network 104 via the network interface 115, such that one, some, or all of the components of the trading device 110 are accessible or can communicate via the communication network 102 and the communication network 104. Additionally, or alternatively, the network interface 115 may couple the bus 111 with other communication networks. The network interface 115 may be, for example, an integrated services digital network (ISDN) card or a modem to provide a data communication connection. As another example, network interface 115 may be a local area network (LAN) card to provide a data communication connection to a compatible LAN, for example, connected to the Internet. Wireless links may also be implemented. The network interface 115 may send and receive electrical, electromagnetic, or optical signals that carry analog or digital data streams representing various type of information.

The display device 116 may a visual output device, cathode ray tube (CRT) display, electronic display, electronic paper, flat panel display, light-emitting diode (LED) displays, electroluminescent display (ELD), plasma display panels (PDP), liquid crystal display (LCD), thin-film transistor displays (TFT), organic light-emitting diode displays (OLED), surface-conduction electron-emitter display (SED), laser television, carbon nanotubes, nanocrystal displays, head-mounted display, projector, three-dimensional display, transparent display device, or other now known or later developed display.

The trading device 110 is adapted to display a trading screen on the display device 116. Trading screens are electronic trading interfaces that enable traders to perform electronic trading acts, such as setting order entry parameters or sending the order entry parameters. Trading screens may also be used for viewing market data. Trading screens may also be used to automate these and additional actions. Trading screens may be provided by a trading application. For example, during operation, X_TRADER® may provide an electronic trading interface, referred to as MD Trader™ in which working orders and bid and ask quantities are displayed in association with a list of price levels.

A trading screen may display market data and may be interactive. An interactive trading screen may allow, for example, one or more trading actions to be performed using the trading screen. For example, an interactive trading screen may allow one or more order entry parameters to be set, sent, or set and sent using one or more order entry actions. The display device 116 or input device 117, for example, may be used to interact with the trading screen.

A trading screen may display one or more trading tools. A trading tool is an electronic tool that allows, assists with, or facilitates electronic trading. Exemplary trading tools include, for example, charts, trading ladders, order entry tools, automated trading tools, automated spreading tools, risk management tools, order parameter tools, order entry systems, market grids, fill windows, and market order windows, combinations thereof, other now known or later developed electronic tools used for trading, preparing to trade, or managing trades.

A trading tool may be used for order management, market analysis, or both order management and market analysis. Order management may include, for example, entering an order, cancelling an order, managing multiple order types, link orders as order-cancels-orders (OCOs), placing orders as trailing stops, changing order quantity or level, displaying a position, displaying an average price, trading multiple accounts, viewing estimated position in a queue, or any combination thereof. Market analytics may include, for example, viewing depth of market (DOM), viewing implied price/volume, viewing volume at price, viewing trade level volume, viewing the inside market, viewing the last trade price and volume, setting an order size, changing a resting order, or any combination thereof.

A trading tool may include one or more order entry cells. An order entry cell may be a region associated with entering a trade order. For example, an order entry cell may be selected to set one or more order entry parameters, send a trade order, or both. An order entry cell may be, for example, a key, button, menu option, charting line, or other now known or later developed region of a trading tool. An order entry cell may be selected using a cursor or pointer that is associated with an input device, such as a mouse. The cursor may be moved over an order entry cell and selected. Once selected, for example, a bid or ask parameter may be set depending on which order entry cell is selected and a trade order may be sent. In other example, an order entry cell may be associated with only setting a parameter.

As mentioned above, FIG. 2 illustrates an example of a trading screen 200 displaying a trading ladder 210. The trading ladder 210 includes a price display 220, a bid quantity display 230, and an ask quantity display 240. The trading ladder 210 may include additional, different, or fewer displays, information, or content. For example, the trading ladder 210 may include a bid quantity indicator display, an ask quantity indicator display, a last traded quantity (LTQ) display, executed/working (E/W) order display, or other region for setting, sending, or displaying a parameter.

The trading ladder 210 may be a trading tool. Alternatively, or additionally, one or more regions of the trading ladder 210 may be trading tools. For example, the bid quantity display 230 or ask quantity display 240 may be trading tools.

The trading ladder 210 may be arranged as shown in FIG. 2. However, other arrangements or designs are possible. For instance, FIG. 2 illustrates a price level of the price display 220 being arranged adjacent to a corresponding bid quantity of the bid quantity display 230 and ask quantity of the ask quantity display 240. However, in other embodiments, the price level does not have to be arranged adjacent to a corresponding bid quantity or ask quantity.

The price display 220 may represent various prices for a tradeable object. For example, as shown, the price display 220 may be a column of prices, where the prices increment in “ticks.” A tick is the minimum change in a price value that is set by the exchange for each tradeable object. The prices can be displayed as ticks, as multiples of ticks or in any other fashion. The price display 220 may list the whole prices or a portion of the whole prices (e.g., just the last two digits). Other price display conventions may alternatively be used, as long as the requisite price information is conveyed to the user. The prices in the price display 220 may be static (e.g., price levels do not normally change position unless a re-centering command is received) or dynamic (e.g., a display that always centers on last traded price).

The bid quantity display 230 may represent quantity of bids at a given price. The ask quantity display 240 may represent quantity of asks at a given price. The bid quantity display 230 may be a column that includes the number of bids for a price in the price display 220 and the ask quantity display 240 may be a column that includes the number offers for a price in the price display 220. The values in the bid quantity display 230 and the ask quantity display 240 may be static or dynamic. For example, the bid quantity and/or ask quantity values may move up and down relative to the associated price levels.

The bid quantity display 230 and ask quantity display 240 may include one or more order entry cells. For example, the bid quantity display 230 may include order entry cell 232. The order entry cell 232 shows the bid quantity for the price level “9433.0.” During operation, the order entry cell 232 may be selected, for example, using a cursor or pointer. In this example, selecting the order entry cell 232 sets a price parameter to 9433.0 and an order type parameter to “Bid.” The quantity parameter may be a default parameter or selected using the cursor or pointer. Selection of the order entry cell 232 may also send a trade order with the specified parameters.

Returning to FIG. 1, the input device 117 may be a keyboard, mouse, microphone, touch-screen, trackball, keypad, joystick, a combination thereof, or other device for providing input, for example. The input device 117 may be used, for example, to provide command selections to processor 112. For example, the input device 117 may be a mouse that is used to control a cursor or pointer displayed on a trading screen. The mouse may include one or more buttons for selection and control, for example.

The output device 118 may include a keyboard, mouse, speakers, touch-screen, trackball, keypad, haptic device or system, joystick, a combination thereof, or other device for providing output. For example, the output device 670 may be used to output one or more signals, such as a haptic signal or an audio signal, to a user.

The gateway 120 is adapted to communicate with the trading device 110 and the exchange system 130 and may facilitate communication between the client device 110 and the server side device 140 and the exchange system 130. For example, the gateway 120 may receive one or more trade orders from the client device 110 and transmit the one or more trade orders to the exchange system 130. As another example, the gateway 120 may receive market data from the exchange 130 and transmit the market data to the trading device 110.

The gateway 120 performs processing on data communicated between the client device 110 and the exchange system 130. For example, the gateway 120 may process a trade order received from the trading device 110 into a data format acceptable by the exchange 130. Similarly, the gateway 120 may transform market data in an exchange-specific format received from the exchange 130 into a format understood by the trading device 110. The processing may include protocol translation or conversion. The processing of the gateway 120 may also include tracking orders from the trading device 110 and updating the status of the order based on fill confirmations received from the exchange system 130, for example. As another example, the gateway 120 may coalesce market data from one or more exchange systems and provide it to the trading device 110.

In general, the exchange system 130 may be owned, operated, controlled, or used by an exchange. Exemplary exchanges include the London International Financial Futures and Options Exchange (“LIFFE”), the Chicago Board of Trade (“CBOT”), and the Chicago Mercantile Exchange (“CME”). The exchange system 110 may be an electronic matching system, such as a computer, server, or other computing device, that is adapted to allow tradeable objects, for example, offered for trading by the exchange, to be bought and sold.

The exchange system 130 is adapted to match quantity of a trade order with quantity of another trade order that can result in an order fill or partial fill. A trade order may include one or more order entry parameters. For matching purposes, the exchange system 110 includes a matching engine adapted to match the trade orders. The exchange system 130 is adapted to match trade orders to buy and sell one or more tradeable objects. The tradeable objects may be listed for trading by the exchange system 130. A trade order may be received from the client device 110 or from the server side device 140. A trade order may also be received from the client device 110 through the gateway 120, for example. In addition, a trade order may be received from other devices in communication with the exchange system 130. Typically the exchange system 130 will be in communication with a variety of other client devices (which may be similar to client device 110) that also provide orders to be matched.

Furthermore, the exchange system 130 is adapted to provide market data. The market data may be provided to the client device 110, for example, through the gateway 120. Once received, the trading device 110 may process and display the market data. If displayed, the market data may be displayed on the display device 116, for example, as part of a trading screen.

As mentioned above, the trading system 100 may include a server side device 140. The server side device 140 may be a server, gateway, personal computer, remote processing device, a combination thereof, or other computing device. For example, the server side device 140 may be a trading server that is co-located at the exchange system 130. In another example, the server side device 140 may be a server running an automated trading tool, such as Autospreader® or Autotrader™, both of which are provided by Trading Technologies International, Inc. The automated trading tool may be controlled using the trading device 110, even though the server, along with the gateway 120, may be physically located at, in, around, or near the exchange system 130.

The server side device 140 may provide processing at a site that is physically located closer to the exchange system 130 than the trading device 110. Accordingly, all, some, or none of the acts or functions of the trading device 110, the gateway 120, or both the trading device 110 and gateway 120 may be performed by the server side device 140. For example, the exchange system 130 may be running a copy of X_TRADER® that is controlled by the trading device 110.

The server side device 140 may be in communication with and coupled with the gateway 120 via communication network 106. The server side device 140 may receive one or more order entry parameters. The exchange system 130 may submit a trade order to the exchange system 130, for example, via the gateway 120. The trade order may include one or more the of the order entry parameters received from the trading device 110. The server side device 140 may also be adapted for working the trade order with the exchange system 130. Working a trade order may include submitting a trade order, re-quoting a trade order, cancelling a trade order, sending a hedge order, managing a trade order, or any combination thereof.

In some embodiments, the server side device 140 may be adapted to communicate directly with the exchange system 130 and may be able to communicate with the exchange system 130 without the gateway 120. For example, in an embodiment, the server-side device, if collocated at the exchange, will not have a connection to the gateway (which is likely at the customer's premises) but to the exchange directly, or via another instance of a gateway which is also collocated at an exchange.

Before explaining further, it is noted that the trading system 100 is provided as an exemplary embodiment. The configuration and arrangement may change depending on the exact implementation. For example, the configuration and arrangement may change depending on the requirements of the electronic exchange. Furthermore, other now known or later developed components may be incorporated into the trading system 100.

### IX. Conclusion

While the inventions have been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from the spirit or scope of the present inventions. Therefore, it is intended that the inventions not be limited to the particular embodiments disclosed herein.

1. A method comprising:
receiving, by a computer device at a trading device, market data sent from an electronic exchange, the electronic exchange comprising a matching engine for automatically matching electronic bids and offers for a tradeable object received from a plurality of trading devices, the market data comprising data related to a quantity of unmatched bids or offers at a price level of a price axis for the tradeable object;
selecting, by the computer device, a set of indicators to represent the quantity of unmatched bids or offers at the price level, the set of indicators having a plurality of indicators with a shared characteristic, wherein the shared characteristic corresponds to a specific quantity of bids or offers; and
displaying, by the computer device, the set of indicators representing the quantity of unmatched bids or offers at the price level.

2. The method of claim 1, wherein displaying includes displaying the set of indicators such that the shared characteristic comprises a shared size and a shared shape.

3. The method of claim 1, wherein displaying includes displaying the set of indicators with the shared characteristic such that the indicators are spaced apart from each other.

4. The method of claim 1, further comprising optimally selecting, by the computer device, the set of indicators.

5. The method of claim 1, wherein the shared characteristic is a non-textual characteristic.

6. The method of claim 5, wherein the non-textual characteristic includes at least one of size, shape, color, and shading.

7. The method of claim 1, further comprising associating, by the computer device, the shared characteristic with the specific quantity of bids or offers using a configuration screen.

8. The method of claim 1, further comprising displaying, by the computer device, the set of indicators such that a user can determine the specific quantity of bids or offers being represented without viewing a textual representation of the specific quantity of bids or offers.

9. The method of claim 1, further comprising displaying the set of indicators along a directed axis of layout perceived as orthogonal to the two-dimensional layout of the interface.

10. The method of claim 1, further comprising displaying additional sets of indicators corresponding to quantities of bids or offers from a prior point in time.

11. The method of claim 1, further comprising displaying different types of indicators corresponding to quantities deleted since a prior point in time, quantities added since a prior point in time, and quantities that existed at both a current and prior point in time.

12. Logic encoded in one or more tangible media for execution by a processor and when executed operable to:
receive market data sent from an electronic exchange, the electronic exchange comprising a computerized matching process for automatically matching electronic bids and offers for a tradeable object received from a plurality of trading devices, the market data comprising data related to a quantity of unmatched bids or offers at a price level of a price axis for the tradeable object;
select a set of indicators to represent the quantity of unmatched bids or offers at the price level; and
display a set of indicators representing the quantity of unmatched bids or offers at the price level, the set of indicators having indicators with a shared characteristic, wherein the shared characteristic corresponds to a specific quantity of bids or offers.

13. The logic of claim 12, wherein the logic, when executed, is operable to display the set of indicators such that the shared characteristic comprises a shared size and a shared shape.

14. The logic of claim 13, wherein the logic, when executed, is operable to display the set of indicators with the shared characteristic such that the indicators are spaced apart from each other.

15. The logic of claim 12, wherein the logic, when executed, is operable to optimally select the indicators in the set of indicators.

16. The logic of claim 12, wherein the shared characteristic is a non-textual characteristic.

17. The logic of claim 12, wherein the indicators are displayed such that a user can determine the specific quantity of bids or offers being represented without viewing a textual representation of the specific quantity of bids or offers.

18. A method comprising:
receiving, by a computer device, market data sent from an electronic exchange, the electronic exchange comprising a computerized matching process for automatically matching electronic bids and offers for a tradeable object received from a plurality of trading devices, the market data comprising data related to quantity of unmatched bids or offers at a price level;
selecting, by the computer device, a first set of indicators to represent a first portion of the quantity of unmatched bids or offers at the price level, the first set of indicators having a plurality of indicators with a first shared characteristic, wherein the first shared characteristic corresponds to a specific quantity of bids or offers;
selecting, by the computer device, a second set of indicators to represent a second portion of the quantity of unmatched bids or offers at the price level, the second set of indicators having a plurality of indicators with a second shared characteristic, wherein the second shared characteristic corresponds to a specific quantity of bids or offers; and
displaying, by the computer device, the first and second sets of indicators representing the quantity of unmatched bids or offers at the price level.

19. The method of claim 18, wherein the first shared characteristic is different than the second shared characteristic.

20. The method of claim 18, wherein the quantity of bids or offers being represented by the first and second portions equals the quantity of unmatched bids or offers at that price level.

21. The method of claim 18, wherein the first and second shared characteristics are non-textual characteristics.

22. The method of claim 18, wherein the first and second sets of indicators ascend and descend the price axis with the price level.

23. The method of claim 18, wherein the first and second sets of indicators are optimally selected.
